(19) United States
(12) Patent Application Publication
(10) Pub. No.: US 2022/0251305 A1
(43) Pub. Date: Aug. 11, 2022

(54) RESIN COMPOSITION FOR 3D PRINTING

(71) Applicant: QUARZWERKE GmbH, Frenchen (DE)

(72) Inventors: Robert SZILLUWEIT, Erftstadt (DE); Dirk KRUBER, Alfter (DE); Jörg Ulrich ZILLES, Köln (DE); Olaf MÜHLING, Frenchen (DE)

(21) Appl. No.: 17/625,454

(22) PCT Filed: Jul. 10, 2020
(86) PCT No.: PCT/EP2020/069481

§ 371 Date: Jan. 7, 2022

(30) Foreign Application Priority Data
Jul. 11, 2019 (EP) 19185772.1

(51) Int. Cl. C08G 77/458; C08K 3/36

(52) U.S. Cl. CPC C08G 77/458; C08K 3/36; C08K 2201/011; C08K 2201/006; C08K 2201/005

(57) ABSTRACT

A radiation-curable resin composition, comprising
from 0 to 30% by weight of one or more oligomers;
from 15 to 80% by weight of one or more monomers;
from 10 to 80% by weight of a filler mixture;
from 0.1 to 5% by weight of one or more photoinitiators;
   wherein the filler mixture includes:
from 39.9 to 90% by weight of first particles having a grain size d50ᵥₒₗ of 3 to 20 μm;
from 9.9 to 60% by weight of second particles having a grain size d50ᵥₒₗ of 0.5 to 1 μm;
from 0.1 to 5% by weight of nanoparticles having a BET surface area within a range of from 10 to 100 m²/g.

The present invention relates to a radiation-curable resin composition.

In the so-called 3D printing, also known under the designation of additive manufacturing, three-dimensional models can be produced by applying materials layer by layer. Depending on the selected method, the build-up of the model is effected from thermoplastics, powders, or radiation-curable resins. The thickness of the layers is typically within a range of from 0.025 to 0.100 mm, but may also be up to 0.200 mm One field of 3D printing, which is stereolithography, uses radiation-curable resins, inter alia. In this method, radiation-curable compositions based on acrylics, epoxy or vinyl ester are applied and subsequently cured, typically using a laser.

It is known to fill the radiation-curable resins with fillers in order to improve the mechanical properties of the final product in view of its application.

For example, EP 2 868 692 B1 describes a matrix-filled radiation-curable resin composition for corresponding methods.

Despite numerous developments, there is still a need for alternative radiation-curable resin compositions for use in 3D printing, which possibly exhibit better properties of the product, for example, a high heat deflection temperature and high rigidity, as compared to the prior art.

This object is achieved by a radiation-curable resin composition, comprising
from 0 to 30% by weight of one or more oligomers;
from 15 to 80% by weight of one or more monomers;
from 10 to 80% by weight of a filler mixture;
from 0.1 to 5% by weight of one or more photoinitiators;

wherein the filler mixture includes:
from 39.9 to 90% by weight of first particles having a grain size d50ᵥₒₗ of 3 to 20 μm;
from 9.9 to 60% by weight of second particles having a grain size d50ᵥₒₗ of 0.5 to 1 μm;
from 0.1 to 5% by weight of nanoparticles having a BET surface area within a range of from 10 to 100 m²/g.

In another embodiment, the object is achieved by a radiation-curable resin composition, comprising
from 0 to 30% by weight of one or more oligomers;
from 1 to 50% by weight of one or more monomers;
from 20 to 75% by weight of a filler mixture;
from 0.1 to 5% by weight of one or more photoinitiators;

wherein the filler mixture includes:
from 40 to 80% by weight of first particles having a grain size d50ᵥₒₗ of 3 to 20 μm;
from 20 to 60% by weight of second particles having a grain size d50ᵥₒₗ of 0.5 to 1 μm;
from 0.5 to 3% by weight of nanoparticles having a BET surface area within a range of from 10 to 100 m²/g.

Further ingredients may be included, but preferably not more than 10% by weight.

Examples of further ingredients include dispersants, antistatic agents, flame retardants, colorants, polymerization retarders (inhibitors), thermal polymerization initiators as well as stabilizers, such as antioxidants and light protectants (UV absorbers, HALS compounds).

Within the scope of the present invention, the prefix “Cx-Cy-” (with x and y=1, 2, 3, etc., and y>x) designates that the related alkyl compound, class of compounds or group may consist of x to y carbon atoms. “(Meth)acryl” represents acryl or methacryl compounds, “(hetero)aromatic” represents aromatic or heteroaromatic compounds, and “(hetero)cyclic” represents cyclic or heterocyclic compounds.

The radiation-curable resin composition contains oligomers, inter alia.

An oligomer is a macromolecule that is constituted of several structurally identical or similar monomer units. The exact number of monomer units is not defined, but is usually from 10 to 100, especially from 10 to 30. When the number of units is larger, the material is mostly referred to as a polymer.

Preferably, the oligomers include free-radically polymerizable, ethylenically unsaturated groups, for example, (meth)acrylate groups. In some embodiments, oligomers may have a (poly)urethane skeleton.

Particularly suitable oligomers may be classified into the groups of aliphatic urethane (meth)acrylates, aromatic urethane (meth)acrylates, polyester (meth)-acrylates, and epoxy (meth)acrylates.

Suitable oligomers are commercially available, for example, under the product names of Ebecryl (company Allnex), Sartomer (company Arkema Group), and Genomer (company Rahn AG).

In addition to the actual oligomers, many commercial oligomers contain further ingredients, mostly low-molecular ones, often referred to as “reactive thinners”.

The amount of oligomer is from 0 to 30% by weight, based on the radiation-curable resin composition, preferably within a range of from 0 to 10% by weight.

In another embodiment, the amount of the oligomer is from 0 to 30% by weight, based on the radiation-curable resin composition, preferably within a range of from 3 to 7% by weight.

The radiation-curable resin composition contains monomers as a further component.

In general, monomers are low-molecular reactive compounds that may be bonded together to form oligomers or polymers.

According to the invention, all compounds that have at least one free-radically polymerizable ethylenic double bond may be employed as monomers.

Monomers may be distinguished by the number of their free-radically polymerizable ethylenic double bonds. Monomers having one free-radically polymerizable ethylenic double bond are monofunctional (monomers I). Monomers having several free-radically polymerizable, non-conjugated, ethylenic double bonds are polyfunctional (monomers II). Monomers II have a cross-linking effect.

Monomers I are preferably selected from the group of:
Ia) esters of α,β-ethylenically unsaturated C3-C4 carboxylic acids;
Ib) vinyl (hetero)aromatics;
Ic) α,β-ethylenically unsaturated mono- and dicarboxylic acids, carboxylic acid anhydrides, and carboxylic acid amides;
Id) the mono- and diesters of α,β-ethylenically unsaturated C4-C6 dicarboxylic acids; and
Ie) the allyl and vinyl esters of carboxylic acids.

More preferably, the monomers I are selected from groups Ia), Ib), and Ic).

Suitable monomers I from group Ia) include
(meth)acrylates of unbranched, branched and cyclic alkanols with 1 to 22 carbon atoms in the alkanol residue, such as methyl (meth)acrylate, ethyl (meth)acrylate, n-butyl (meth)acrylate, tert-butyl (meth)acrylate, ethylhexyl (meth)acrylate, isodecyl methacrylate, isobornyl (meth)acrylate, and 4-tert-butylcyclohexyl (meth)acrylate.
aromatic and heteroaromatic (meth)acrylates, such as benzyl (meth)acrylate, 2-hydroxy-3-phenoxypropyl (meth)acrylate, phenoxyethyl (meth)acrylate, phenyl (meth)acrylate, pentabromobenzyl (meth)acrylate, pentabromophenyl (meth)acrylate, 2,4,6-tribromophenyl (meth)acrylate, 9H-carbazol-9-ethyl (meth)acrylate, 2-hydroxypropyl-2-([meth]acryloyloxy)ethyl phthalate, 1-naphthyl (meth)acrylate, and 1-pyrenylmethyl (meth)acrylate.
hydroxy-, alkoxy-, carboxy-, amino-, epoxy-, sulfo-, silyl- and halo-substituted alkyl (meth)acrylates as well as heterocyclic (meth)acrylates, such as 2-hydroxyethyl, 2-hydroxypropyl, 3-hydroxypropyl, 2-hydroxybutyl, 3-hydroxybutyl, 5-hydroxybutyl, hydroxyethylcaprolactone, 3-chloro-2-hydroxypropyl, 2-methoxyethyl, 2-ethoxyethyl, 2-butoxyethyl, di(ethylene glycol) methyl ether, di(ethylene glycol) ethyl ether, di(ethylene glycol)-2-ethylhexyl ether, tri(ethylene glycol) methyl ether, ethylene glycol dicyclo-pentenyl ether, ethyldiglycol, ethyltriglycol, butyldiglycol, 2-carboxyethyl, 2-(dimethylamino)ethyl, 2-(diethylamino)ethyl, 2-(diisopropylamino)ethyl, 2-(tert-butylamino)ethyl, 3-(dimethylamino)propyl, 2-[[(butylamino)carbonyl]oxy] ethyl, glycidyl, 2-(methylthio)ethyl, 3-(trimethoxysilyl)propyl, 2-(trimethylsilyloxy)ethyl, 3-[tris(trimethylsiloxy)silyl]propyl, trimethylsilyl, 2-chloroethyl, 2,2,2-trifluoroethyl, tetrahydrofurfuryl and 2-N-morpholinoethyl (meth)acrylate, and 4-(meth)acryloylmorpholine, mono-2-([meth]acryloyloxy)ethyl succinate, and mono-2-([meth]acryloyloxy)ethyl maleate.

Suitable monomers I from group Ib) include, for example, styrene, 4-acetoxystyrene, 2-bromostyrene, 3-bromostyrene, 4-bromostyrene, 4-tert-butoxystyrene, 4-tert-butylstyrene, 2-chlorostyrene, 3-chlorostyrene, 4-chlorostyrene, 2,6-dichlorostyrene, 3,4-dimethoxystyrene, 2,4-dimethylstyrene, 2,5-dimethylstyrene, 4-ethoxystyrene, 3-methylstyrene, 4-methylstyrene, 4-vinylanisole, 3-vinylbenzylchloride, 4-vinylbenzylchloride, 9-vinylanthracene, 4-vinylbiphenyl, 2-vinylnaphthalene, 9-vinylcarbazole, N-vinylphthalimide, 2-vinylpyridine, 4-vinylpyridine, and 1-vinyl-2-pyrrolidinone.

Suitable monomers I from group Ic) include, for example, (meth)acrylic acid, maleic acid, itaconic acid, maleic anhydride, itaconic anhydride, crotonic acid anhydride, N-ethyl-, N-isopropyl-, N-tert-butyl-, N,N-dimethyl-, N,N-diethyl-, N-hydroxymethyl-, N-hydroxyethyl-, N-(3-methoxypropyl)-, N-(butoxymethyl)-, N-(isobutoxymethyl)-, N-phenyl-, N-diphenylmethyl-, N-(triphenylmethyl)-, and N-[3-(dimethylamino)propyl](meth)acrylamide.

Suitable monomers I from group Id) include, for example, the diesters of maleic and itaconic acids with methanol, ethanol, n-butanol, isobutanol, and 2-ethylhexanol.

Suitable monomers I from group Ie) include, for example, vinyl and allyl acetates, and the corresponding propionates, butyrates, valerates, capronates, decanoates, and laurates.

As polyfunctional monomers II, there may be used:
IIa) the (meth)acrylic acid esters of polyhydric alcohols;
IIb) the vinyl and allyl ethers of polyhydric alcohols; and
IIc) twice or several times allyl-, vinyl- or (meth)acryl-substituted (hetero)cyclic and (hetero)aromatic compounds.

Suitable polyfunctional monomers II from group IIa) include, for example, ethylene glycol di(meth)acrylate, 1,3-butanediol di(meth)acrylate, 1,4-butanediol di(meth)acrylate, 1,6-hexanediol di(meth)acrylate, 1,10-decanediol di(meth)acrylate, di(ethylene glycol) di(meth)acrylate, tri(ethylene glycol) di(meth)acrylate, tetra(ethylene glycol) di(meth)acrylate, di(propylene glycol) di(meth)acrylate, tri(propylene glycol) di(meth)acrylate, tricyclodecanedimethanol di(meth)acrylate, 2-hydroxy-1,3-di(meth)acryloxypropane, glycerol di(meth)acrylate, glycerol 1,3-diglycerolate di(meth)acrylate, neopentylglycol di(meth)acrylate, diurethane di(meth)acrylate, trimethylolpropane ethoxylate methyl ether di(meth)acrylate, trimethylolpropane tri(meth)acrylate, trimethylolpropane ethoxylate tri(meth)acrylate (EO degree=3-20), trimethylolpropane propoxylate tri(meth)acrylate, pentaerythritol tri(meth)acrylate, glycerol propoxylate tri(meth)acrylate, di(trimethylol)propane tetra(meth)acrylate, pentaerythritol tetra(meth)acrylate, di(pentaerythritol) penta(meth)acrylate, and di(pentaerythritol) hexa(meth)acrylate.

Suitable polyfunctional monomers II from group IIb) include, for example, 1,4-butanediol divinyl ether, 1,6-hexanediol divinyl ether, di(ethylene glycol) divinyl ether, bis[4-(vinyloxy)butyl]adipate, bis[4-(vinyloxy)butyl]succinate, bis[4-(vinyloxy)butyl]isophthalate, bis[4-(vinyloxy)butyl]terephthalate, bis[4-(vinyloxy)butyl]-1,6-hexanediyl biscarbamate, 1,4-cyclohexanedimethanol divinyl ether, tris[4-(vinyloxy)butyl]trimellitate, allyl ether, and trimethylolpropane diallyl ether.

Suitable polyfunctional monomers II from group IIc) include, for example, divinylbenzene, 2,4,6-triallyloxy-1,3,5-triazine, 1,3,5-triallyl-1,3,5-triazine-2,4,6(1H,3H,5H)-trione, tris[2-(acryloyloxy)ethyl] isocyanurate, 1,3,5-triacryloylhexahydro-1,3,5-triazine, 2,2′-diallylbisphenol-A, 2,2′-diallylbisphenol-A diacetate ether, 1,4-phenylene di(meth)acrylate, bisphenol-A ethoxylate di(meth)acrylate (EO degree=2-30), bisphenol-A glycerolate di(meth)acrylate, bisphenol-A propoxylate glycerolate di(meth)acrylate, bisphenol-A di(meth)acrylate, and bisphenol-F ethoxylate di(meth)acrylate.

The amount of the monomers is from 15 to 80% by weight, based on the radiation-curable resin composition, preferably from 15 to 50% by weight.

In another embodiment, the amount of the monomers is from 1 to 50% by weight, based on the radiation-curable resin composition, preferably from 15 to 40% by weight.

The free-radically polymerizable composition of monomers and optionally oligomers is hereinafter also referred to as a resin, i.e., without fillers. “Radiation-curable composition” or “radiation-curable resin composition” relates to the mixture of resin and fillers.

The radiation-curable resin composition contains a filler mixture as a further component. Fillers are inorganic materials.

The filler mixture contains particles in at least three grain size ranges.

The grain sizes of the first and second particles are in the submicrometer to micrometer range.

They are characterized by a d50ᵥₒₗ value. This is the grain size at which 50% by volume of the particles have a larger grain size, and 50% by volume of the particles have a smaller grain size, as compared to the d50ᵥₒₗ value.

Such grain sizes can be determined, for example, by laser diffractometry. The determination of the grain size was effected according to ISO 13320. A suitable device for this purpose is CILAS 1064 from the company Quantachrome. The following method is employed for determining the grain sizes: The individual fractions of the fillers are dispersed in isopropanol using ultrasound and stirring. The weighed amount of filler depends on the turbidity of the dispersing liquid. this is defined by the obscuration (darkening). The obscuration of the dispersing liquid should be from 15-20%. Depending on the obscuration, the weighed amounts may be several grams to a few milligrams.

Particularly suitable materials for the first and second particles include fillers selected from the group consisting of amorphous silicon dioxide, crystalline silicon dioxide, feldspar, mica, anhydrite (calcium sulfate), and mixtures thereof.

In particular, potash feldspar, sodium feldspar and so-called feldspathoids, and mixed compositions resulting therefrom are suitable as said feldspar.

The filler mixture contains nanoparticles as the third particles. Within the scope of this invention, “nanoparticles” means particles having an average primary particle diameter of from 1 nm to 100 nm. The particle size of nanoparticles usually cannot be reliably determined by laser diffractometry. Other methods, such as dynamic light scattering (DLS), are more suitable for this.

BET values are often stated for nanoparticles. The BET measurement is an analytical method for determining the specific surface area (m²/g) by means of gas adsorption. The abbreviation BET represents the last names of the inventors Brunauer, Emmett, and Teller. The measurements for determining the BET surface area are performed according to DIN ISO 9277.

In particular, materials consisting of amorphous silicon dioxide and having a BET surface area within a range of from 10 to 100 m²/g are suitable as said third particles (nanoparticles).

The filler mixture is contained in a proportion of from 10 to 80% by weight in the radiation-curable resin composition.

In another embodiment, the filler mixture has a proportion of 5 to 75% by weight in the radiation-curable resin composition.

Preferably, the content of the filler mixture is at least 15% by weight, more preferably at least 25% by weight, or 35% by weight, or at least 50% by weight. Filler contents within a range of from 55 to 70% or from 55 to 75% by weight are particularly preferred.

The higher the filling degree, the better are the mechanical properties to be expected, and/or the higher is the rigidity of the fully cured resin composition.

In some embodiments, the first particles are silanized.

In a second embodiment, the second particles are silanized.

In a third embodiment, the third particles are silanized.

In a fourth embodiment, both the first and the second particles are silanized

In a fifth embodiment, both the first and the second and third particles are silanized

“Silanization” means the coating of the particle surface with silane compounds. The bonding is effected through condensation reactions between hydrolyzable groups of the silanes employed and chemical groups at the particle surface.

The silanization can be effected, for example, by a treatment with triethoxyvinyl silane, trimethoxyvinyl silane, or methacryloxypropyltrimethoxysilane. Those skilled in the art know of further suitable silanizing agents. Different particles may also be silanized with different agents or mixtures of agents.

It is preferred for the first particles to be spherical. Since the first particles are relatively large (3 to 20 μm), the spherical character can be observed simply by a light microscope. Such analyses may also be automated, for example, by devices sold under the name of QICPIC® from the company

Sympatec GmbH of Clausthal-Zellerfeld, Germany.

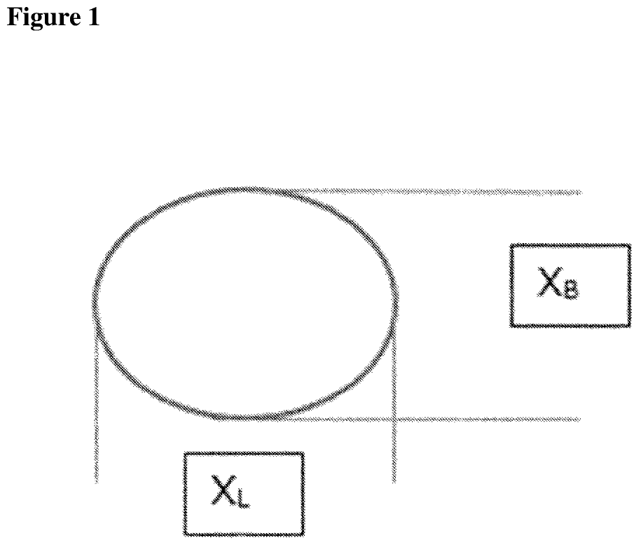

Sphericity is a measure of the extent to that the shape of a body approaches that of a sphere. It can be determined via the width-to-length ratio X_{B}/X_{L} of the measured particles. For a sphere, this ratio equals 1. The smaller value is always to be defined as the width. This is schematically shown in FIG. 1.

“Spherical” within the meaning of this application are particles in which the width-to-length ratio is at least 0.80, more preferably 0.90.

Further, the radiation-curable resin composition contains a photoinitiator.

Photoinitiators are chemical compounds that, upon absorption of electromagnetic radiation, often (UV) light in a wavelength range of about 250-400 nm, decay in a photolytic reaction and thus form reactive species, which can initiate a chemical reaction, mostly a polymerization. These reactive species are free radicals or cations. In the present invention, free-radical forming photoinitiators are used.

In principle, any chemical compound that forms free radicals when exposed to a suitable radiation may be employed as the photoinitiator. The group of suitable photoinitiators includes, inter alia:
1. α-hydroxyarylketones, such as 2-hydroxy-2-methylpropiophenone, 1-hydroxycyclohexylphenylketone,
2. α-aminoarylketones, such as 2-methyl-4′-(methylthio)-2-morpholinopropiophenone, 2-benzyl-2-(dimethylamino)-4′-morpholinobutyrophenone,
3. α-alkoxyarylketones, such as 2,2-dimethoxy-2-phenylacetophenone, 2-isopropoxy-2-phenylacetophenone, 2-n-butoxy 2-phenylacetophenone,
4. phosphine oxides, such as diphenyl-(2,4,6-trimethylbenzoyl)-phosphine oxide, ethyl(2,4,6-trimethylbenzoyl)phenyl phosphinate, phenyl-bis-(2,4,6-trimethylbenzoyl)phosphine oxide.

Preferred photoinitiators belong to the group of phosphine oxides. These are widespread and are readily available even on an industrial scale. Typical amounts thereof are from 0.1 to 5.0% by weight. Photoinitiators that can be activated with radiation within a wavelength range of from 355 to 405 nm are preferred.

Examples thereof include the substances also sold under the trade names of Omnirad TPO, CHIVACURE TPO, GENOCURE TPO, Omnirad TPO-L, CHIVACURE TPO-L, GENOCURE TPO-L, Lucirin BAPO, Irgacure 819.

The incorporation of the filler mixtures into resins may be effected through different mixing and dispersing systems, such as dissolvers, planetary mixers, paddle mixers, rotor-stator dispersers (e.g., Ultra-Turrax®), or mixers functioning according to the principle of a dual asymmetric centrifuge (DAC). On a laboratory scale, DAC mixers offer a quick and simple dispersion of particles even in highly viscous matrices with simultaneous degassing.

The flexural modulus and the heat deflection temperature of cured resin compositions may often be increased by raising the filler proportion in the resin composition. With many commercial resins, an increase of the filling degree is not possible because the raise in viscosity associated therewith does not allow for any further processing. In order to be able to set filling degrees of more than 50% by weight, the viscosity of the unfilled resin should be as low as possible.

The resin without the filler mixture preferably has a viscosity within a range of from 10 to 1000 mPa·s, more preferably within a range of from 10 to 100 mPa·s, as measured at 25° C. and at a shear rate of 10 s⁻¹ with a plate-plate geometry.

The radiation-curable resin composition according to the invention preferably has a viscosity of at most 3000 mPa·s at a shear rate of 10 s⁻¹, and at most 15,000 mPa·s at a shear rate of 0.1 s⁻¹, respectively measured at 25° C. and with a plate-plate geometry.

The invention also relates to a radiation-cured resin composition obtainable by radiation curing the radiation-curable resin composition according to the invention.

The thus obtained cured resin compositions are characterized by good mechanical properties and a high heat deflection temperature.

Thus, the flexural modulus of elasticity according to ISO 178 of the cured resin composition is preferably within a range of from 6,000 to 12,000 MPa, more preferably at least 7,000 MPa.

Preferably, the heat deflection temperature (HDT A) according to ISO 75 is at least 100° C. The invention is further illustrated by the following Examples:

### EXAMPLES

### Abbreviations and Parameters Employed

| | |
|---|---|
| MST | methacryloxypropyltrimethoxysilane |
| a-SiO₂ | amorphous silicon dioxide |
| E_{f} | flexural modulus of elasticity or flexural modulus in |
| | Megapascal (MPa) according to ISO 178 |
| ε_{fB} | bending strain at break in percent (%)according |
| | to ISO 178 |
| σ_{fB} | bending stress at break in Megapascal (MPa)according |
| | to ISO 178 |
| HDT A | heat deflection temperature in degree centigrade (° C.) |
| | according to method A of ISO 75 |
| n.d. | not determined |

### Preparation of the Resin (for Examples 4 to 7)

The photoinitiator GENOCURE TPO is completely dissolved in the monomer SARTOMER SR 351 at room temperature and with stirring. Subsequently, the remaining components of the resin (SARTOMER SR 306, GENOMER 4425, EPDXY METHACRYLATE 97-053) are added. The mixture is stirred until a homogeneous mixture is obtained.

### Preparation of the Resin Compositions (for Examples 4 to 7)

A DAC mixer from the company Hauschild (Speedmixer DAC 400 FVZ) was used for preparing the resin compositions. In a plastic beaker suitable for the Speedmixer (750 ml), 60 g of the resin (50% by weight of the total amount of resin) and 90 g of the filler mixture (50% by weight of the total amount of the filler mixture) are charged, and dispersed at 2,200 rpm for 2 min Subsequently, the remaining amount of the filler mixture (50% by weight of the total amount) is added, and again dispersed at 2,200 rpm for 2 min. In the third step, the remaining amount of the resin (50% by weight of the total amount) is added, followed by another 2 min of dispersing at 2,200 rpm. The resulting resin composition has a filler content of 60% by weight.

### Viscosity Measurements

The viscosity of resins and resin compositions was determined with a rheometer MCR 102 from the company Anton Paar. The following setting was selected:

Geometry=50 mm plate-plate, measuring temperature=25° C., shear rates=0.1 s⁻¹ and 10 s⁻¹.

### 3D Printing of Test Specimens of the Cured Resin Composition

The radiation-curable resin compositions are printed to test specimens of the cured resin composition using a printer of the type SolFlex 650 of the company Way2Production (W2P).

### Post-Curing of the Test Specimens of the Cured Resin Composition

After the printing, the test specimens of the cured resin composition are after-cured using a UV lamp (company Kulzer HiLite Power, emitted wavelength=390-540 nm) on both sides for 180 s.

### Mechanical Properties of the Cured Resin Composition

The test specimens have the following dimensions: length 1=(80±2) mm, width b=(10±0.2) mm, thickness h=(4±0.2) mm

The bending properties are determined according to ISO 178.

The heat deflection temperature is determined according to ISO 75, method A. The heating rate of the oil bath is 50 K/h.

### Example 1 (Comparison)

The commercial resin Prototype Clear of the company Way2Production was filled with 50% by weight of an amorphous silicon dioxide (d50=5 μm) according to the principle of the method described above. The resin composition has a viscosity of 5,000 mPa·s (shear rate=0.1 s⁻¹), or of 10,000 mPa·s (shear rate=10 s⁻¹). Because of the high viscosity, this resin composition is not suitable for 3D printing.

### Example 2 (Comparison)

By analogy with Example 1. Instead of the unsilanized filler, an amorphous silicon dioxide silanized with MST (d50=5 μm) was used.

The resin composition shows a good flowability. The viscosity is 4,000 mPa·s (shear rate=0.1 s⁻¹), or 5,700 mPa·s (shear rate=10 s⁻¹). After storage at 50° C. for 6 hours already, the resin composition shows clearly visible sedimentation. Thus, this resin composition is not permanently stable when stored.

A freshly prepared sample of the resin composition was further processed into test specimens of the cured resin composition according to the above mentioned methods. The mechanical properties can be seen from Table 1.

### Example 3 (Comparison)

By analogy with Example 2. Instead of an MST-silanized filler, two MST-silanized fillers having different grain size distributions were used (80% by weight of an amorphous silicon dioxide with a d50 of 5 μm, 20% by weight of an amorphous silicon dioxide with a d50 of 1 μm).

The resin composition shows a good flowability. The viscosity is 4,200 mPa·s (shear rate=0.1 s⁻¹), or 4,400 mPa·s (shear rate=10 s⁻¹). After storage at 50° C. for 6 hours already, the resin composition shows clearly visible sedimentation. Thus, this resin composition is not permanently stable when stored.

A freshly prepared sample of the resin composition was further processed into test specimens of the cured resin composition according to the above mentioned methods. The mechanical properties can be seen from Table 1.

TABLE 1

| | | | | |
|---|---|---|---|---|
| Parameter | Unit | Example 1 | Example 2 | Example 3 |

Bending properties according to ISO 178

| | | | | |
|---|---|---|---|---|
| E_{f} | MPa | n.d. | 6,500 | 6,400 |
| ε_{fB} | MPa | n.d. | 142 | 154 |
| σ_{fB} | % | n.d. | 3.1 | 3.6 |

Heat deflection temperature according to ISO 75

| | | | | |
|---|---|---|---|---|
| HDT A | ° C. | n.d. | 70 | 71 |

The cured resin compositions from Examples 2 and 3 show very good stresses at break and strains at break. However, the flexural modulus is still too low for many applications. The same holds for the heat deflection temperature.

### Examples 4 to 7

For the Examples 4 to 7, a self-formulated resin with a low viscosity of <100 MPa·s (shear rate=10 s⁻¹) that was prepared by the above described method was used instead of a commercially available resin. By analogy with the preceding Examples 1 to 3, filler mixtures of different compositions were incorporated into the resin by the above described method. The resulting radiation-curable resin compositions were characterized in terms of their viscosity. From the resin composition of Example 7 according to the invention, test specimens were produced by the above described 3D printing method. The test specimens of the cured resin composition were characterized in terms of their bending properties and heat deflection temperature. Details can be seen from Table 2.

Although the resin compositions of Examples 4 and 6 are stable when stored for an extended period of time (no sedimentation), their viscosity is rather a tad high in view of processing in 3D printing. In contrast, the resin composition of Example 5 shows good flow properties, but does not offer permanent stability towards sedimentation. The resin composition of Example 7 according to the invention is both readily processed (good flow properties) and stable when stored (no sedimentation).

In addition, the cured resin composition of Example 7 according to the invention shows good bending properties and a high heat deflection temperature.

TABLE 2

| | | Example 4 | | Example 5 | | | | | |
|---|---|---|---|---|---|---|---|---|---|
| | | Comparison | | Comparison | | Example 6 | | Example 7 | |
| | | [% by weight] | | [% by weight] | | [% by weight] | | [% by weight] | |
| Formulation | Function/Unit | total // relative | | total // relative | | total // relative | | total // relative | |
| SARTOMER SR 306 | Monomer | 15 | | 15 | | 15 | | 15 | |
| GENOMER 4425 | Oligomer | 5 | | 5 | | 5 | | 5 | |
| Epoxy Methacrylate 97-053 | Monomer | 5 | | 5 | | 5 | | 5 | |
| SARTOMER SR 351 | Monomer | 13.5 | | 13.5 | | 13.5 | | 13.5 | |
| GENOCURE TPO | Photoinitiator | 1.5 | | 1.5 | | 1.5 | | 1.5 | |
| Total filler content | | 60 | 100 | 60 | 100 | 60 | 100 | 60 | 100 |
| a-SiO₂, MST-silanized, | first particles of | 48 | 80 | | | | | | |
| d50 = 7 μm | filler mixture | | | | | | | | |
| Spherical a-SiO₂, MST- | first particles of | | | 48 | 80 | 30 | 50 | 48 | 60 |
| silanized, d50 = 5 μm | filler mixture | | | | | | | | |
| a-SiO₂, MST-silanized, | second particles of | 12 | 20 | 12 | 20 | 29.5 | 49.2 | 11.5 | 19.2 |
| d50 = 1 μm | filler mixture | | | | | | | | |
| a-SiO₂, MST-silanized, | nanoparticles of | | | | | 0.5 | 0.8 | 0.5 | 0.8 |
| BET 100 m²/g | filler mixture | | | | | | | | |

| | | | | | |
|---|---|---|---|---|---|
| Total | % by weight | 100 | 100 | 100 | 100 |
| Viscosity at 0.1 s⁻¹ | mPa · s | 67,000 | 6,000 | 31,000 | 12,000 |
| Viscosity at 10 s⁻¹ | mPa · s | 3,000 | 2,000 | 2,500 | 2,000 |

Bending properties of the radiation-cured resin compositions according to ISO 178

| | | | | | |
|---|---|---|---|---|---|
| E_{f} | MPa | n.d. | n.d. | n.d. | 9,000 |
| ε_{fB} | MPa | n.d. | n.d. | n.d. | 67 |
| σ_{fB} | % | n.d. | n.d. | n.d. | 0.8 |

Heat deflection temperature of the radiation-cured resin compositions according to ISO 75

| | | | | | |
|---|---|---|---|---|---|
| HDT A | ° C. | n.d. | n.d. | n.d. | 170 |
| Processability | | viscosity too high | viscosity o.k. | viscosity rather high | viscosity very good |
| Storage stability | | no sedimentation | not stable towards | no sedimentation | no sedimentation |
| | | | sedimentation | | |

1. A radiation-curable resin composition, comprising
from 0 to 30% by weight of one or more oligomers;
from 15 to 80% by weight of one or more monomers;
from 10 to 80% by weight of a filler mixture;
from 0.1 to 5% by weight of one or more photoinitiators;
wherein the filler mixture includes:
from 39.9 to 90% by weight of first particles having a grain size d50ᵥₒₗ of 3 to 20 μm;
from 9.9 to 60% by weight of second particles having a grain size d50ᵥₒₗ of 0.5 to 1 μm;
from 0.1 to 5% by weight of nanoparticles having a BET surface area within a range of from 10 to 100 m²/g.

2. The radiation-curable resin composition according to claim 1, wherein said first or said second particles or both are silanized.

3. The radiation-curable resin composition according to claim 1, wherein said first particles are spherical in shape as measured with a QICPIC® device.

4. The radiation-curable resin composition according to claim 1, wherein said oligomers comprise free-radically polymerizable groups.

5. The radiation-curable resin composition according to claim 1, wherein said monomers have at least one free-radically polymerizable ethylenic double.

6. The radiation-curable resin composition according to claim 1, wherein said first and second particles of the filler mixture are independently fillers selected from the group consisting of amorphous silicon dioxide, crystalline silicon dioxide, feldspar, mica, anhydrite, and mixtures thereof.

7. The radiation-curable resin composition according to claim 6, wherein said feldspar is selected from the group consisting of potash feldspar, sodium feldspar, so-called feldspathoids, and mixtures thereof.

8. The radiation-curable resin composition according to claim 1, wherein said photoinitiator is selected from substances that are active within a wavelength range of from 355 to 405 nm.

9. The radiation-curable resin composition according to claim 1, wherein said resin composition without a filler mixture has a viscosity within a range of from 10 to 1000 mPa·s, as measured at 25° C. and at a shear rate of 10 s⁻¹ with a plate-plate geometry.

10. The radiation-curable resin composition according to claim 1, wherein said radiation-curable resin composition has a viscosity of at most 3000 mPa·s at a shear rate of 10 s⁻¹, and at most 15,000 mPa·s at a shear rate of 0.1 s⁻¹, respectively measured at 25° C. and with a plate-plate geometry.

11. The radiation-curable resin composition according to claim 1, wherein said resin composition does not exhibit any sedimentation of the filler mixture after storage at 25° C. for at least 3 months, as measured by visual inspection.

12. A radiation-cured resin composition obtainable by radiation-curing the resin composition according to claim 1.

13. The radiation-cured resin composition according to claim 12, having a flexural modulus of elasticity according to ISO 178 within a range of from 6,000 to 12,000 MPa.

14. The radiation-curable resin composition according to claim 4, wherein said free-radically polymerizable groups are (meth)acrylate groups.

15. The radiation-curable resin composition according to claim 5, wherein said monomers having at least one free-radically polymerizable ethylenic double bond comprise (meth)acrylate groups.

16. The radiation-curable resin composition according to claim 8, wherein said photoinitiator is selected from substances from the phosphine oxide class of substances.

17. The radiation-cured resin composition according to claim 12, having a heat deflection temperature HDT A according to ISO 75 of at least 100° C.
